(19) United States
(12) Patent Application Publication
(10) Pub. No.: US 2010/0302711 A1
(43) Pub. Date: Dec. 2, 2010

(54) SOLID ELECTROLYTIC CAPACITOR, ELECTRONIC DEVICE USING THE SAME, AND METHOD OF MANUFACTURING THE SAME

(75) Inventors: Kazuhiro KANEDA, Fukaya City (JP); Koichi NISHIMURA, Kadoma City (JP); Hiroshi NONOUE, Hirakata City (JP)

Correspondence Address: MOTS LAW, PLLC, 1629 K STREET N.W., SUITE 602, WASHINGTON, DC, 20006-1635, US

(73) Assignee: SANYO ELECTRIC CO., LTD, Osaka (JP)

(21) Appl. No.: 12/720,242

(22) Filed: Mar. 9, 2010

(30) Foreign Application Priority Data
May 29, 2009 (JP) 2009-130983

(51) Int. Cl. H01G 9/07; C23C 28/00; C25D 11/26

(52) U.S. Cl. 361/524; 205/189; 205/171

(57) ABSTRACT

A solid electrolytic capacitor, an electronic device using the same, and a method for manufacturing the same are disclosed. An aspect of the invention provides a solid electrolytic capacitor including: an anode including any one of niobium or a niobium alloy; a dielectric layer formed on the anode, wherein the dielectric layer contains niobium oxide; and a cathode layer formed on the dielectric layer, wherein the cathode layer contains copper.

### CROSS REFERENCE TO RELATED APPLICATIONS

This application claims the benefit of priority under 35 U.S.C§119 to the prior Japanese Patent Application No. P2009-130983 entitled “SOLID ELECTROLYTIC CAPACITOR, ELECTRONIC DEVICE USING THE SAME, AND METHOD OF MANUFACTURING THE SAME” filed on May 29, 2009, the entire contents of which are incorporated herein by reference.

### BACKGROUND OF THE INVENTION

1. Field of the Invention

The invention relates to a solid electrolytic capacitor using niobium for an anode, an electronic device using the same, and a method for manufacturing the same.

2. Description of Related Art

Solid electrolytic capacitors are used for smoothing the voltage in a power circuit, and for eliminating current noises. Especially, for the purpose of eliminating current noises, solid electrolytic capacitors as “bypass capacitors” or filters are used not only for computers, but also for a wide range of electronic devices such as a digital device.

Reflecting recent trends of miniaturization of electronic devices such as personal computers, solid electrolytic capacitors used in such electronic devices are required to be small but have high capacity. In response to such requirement small-sized/high-capacity solid electrolytic capacitors using niobium (hereinafter “niobium capacitor”) are under development, replacing solid electrolytic capacitors using tantalum (hereinafter “tantalum capacitor”).

Such a niobium capacitor has a dielectric layer containing niobium oxide, which is a dielectric material obtained by anodizing an anode that contains niobium. Because niobium oxide has a dielectric constant that is approximately 1.8 times larger than that of tantalum oxide used for a tantalum capacitor, the niobium capacitor is capable of having higher capacity than that of the tantalum capacitor. Accordingly, in the case of obtaining comparable capacities in a niobium capacitor and a tantalum capacitor, the niobium capacitor has an advantage in terms of its smaller size compared to that of the tantalum capacitor. Therefore, the niobium capacitor is expected to serve as a next-generation solid electrolytic capacitor which is capable of having a small size and a high capacity.

However, current niobium capacitors under development have a disadvantage of an increased leakage current despite its advantage of a high electrostatic capacity as described above (for example, Japanese patent publication 2005-32264).

The solid electrolytic capacitor described in the aforementioned patent publication discloses a conductive polymer layer as a cathode layer, which is formed on a dielectric layer where the dielectric layer is formed on an anode. In the patent publication, reduction of leakage current is attempted by improving the adherence between the dielectric layer and the conductive polymer layer. However, as long as the conductive polymer layer is used in a solid electrolytic capacitor, there is a limit to reducing the leakage current.

### SUMMARY OF THE INVENTION

An aspect of the invention provides a solid electrolytic capacitor including: an anode including any one of niobium and a niobium alloy; a dielectric layer formed on the anode, wherein the dielectric layer contains niobium oxide; and a cathode layer formed on the dielectric layer, wherein the cathode layer contains copper.

Still another aspect of the invention provides a solid electrolytic capacitor including: an anode including any one of niobium and a niobium alloy; a dielectric layer formed on the anode, wherein the dielectric layer contains niobium oxide; and a cathode layer formed on the dielectric layer, wherein the cathode layer contains a copper alloy.

Still another aspect of the invention provides a method of manufacturing a solid electrolytic capacitor, including steps of: forming an anode containing any one of niobium and a niobium alloy; forming a dielectric layer including niobium oxide by anodization so as to cover at least a part of the anode; and forming a cathode layer including any one of copper or copper alloy, so as to cover at least a part of the dielectric layer.

### BRIEF DESCRIPTION OF THE DRAWINGS

FIG. 1 is a cross-sectional view describing a niobium capacitor according to a first embodiment.

FIG. 2 is a perspective view describing the arrangement of a cathode layer of the niobium capacitor according to the first embodiment.

FIGS. 3A to 3F are figures describing steps for manufacturing the niobium capacitor according to the first embodiment.

FIG. 4 is a cross-sectional view describing a niobium capacitor according to a second embodiment.

FIG. 5 is a cross-sectional view describing a niobium capacitor for an evaluation sample.

### DETAILED DESCRIPTION OF EMBODIMENTS

Embodiments of the invention are explained with reference to the drawings. In the respective drawings referenced herein, the same constituents are designated by the same reference numerals and duplicate explanation concerning the same constituents is omitted. All of the drawings are provided to illustrate the respective examples only. No dimensional proportions in the drawings shall impose a restriction on the embodiments. For this reason, specific dimensions and the like should be interpreted with the following descriptions taken into consideration. In addition, the drawings include parts whose dimensional relationship and ratios are different from one drawing to another.

Prepositions, such as “on”, “over” and “above” may be defined with respect to a surface, for example a layer surface, regardless of that surface's orientation in space. The preposition “above” may be used in the specification and claims even if a layer is in contact with another layer. The preposition “on” may be used in the specification and claims when a layer is not in contact with another layer, for example, when there is an intervening layer between them.

### First Embodiment

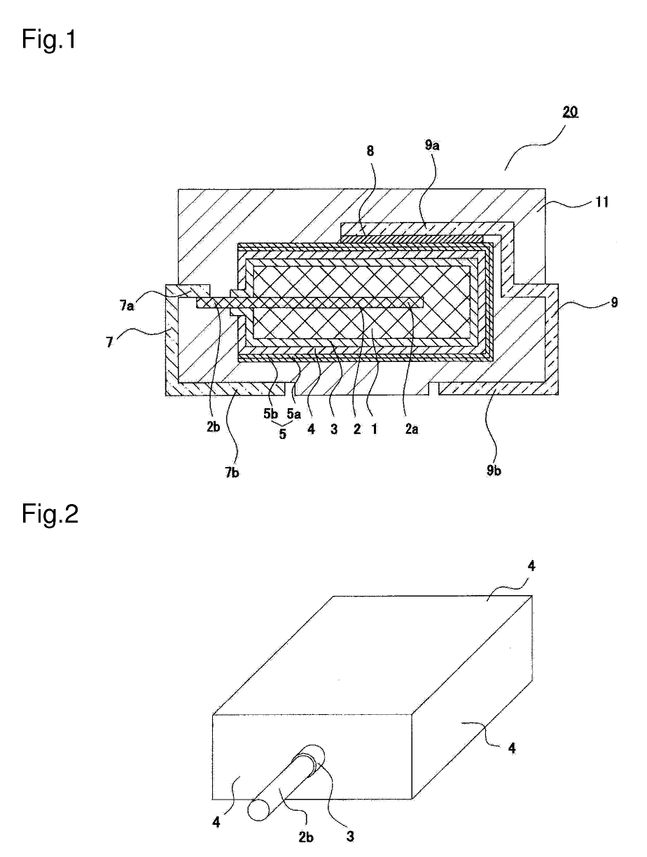

FIG. 1 is a schematic cross-sectional view describing the inside of a niobium capacitor according to a first embodiment.

Niobium capacitor 20 according to the embodiment has an outer shape of a rectangular parallelepiped. Niobium capacitor 20 includes anode 1 that contains niobium, anode lead 2, dielectric layer 3, cathode layer 4 and cathode lead layer 5, as shown in FIG. 1. Anode lead 2 is provided so that end portion 2a is embedded in anode 1 while the other end portion 2b protrudes from anode 1. Dielectric layer 3 containing niobium oxide is formed by anodizing anode 1. Cathode layer 4 covers dielectric layer 3. Cathode lead layer 5 covers cathode layer 4. Anode terminal 7 is connected to end portion 2b of anode lead 2. Cathode terminal 9 is bonded to cathode lead layer 5 with a conductive adhesive 8. Outer resin package 11 is formed so as to expose a part of anode terminal 7 and a part of cathode terminal 9.

A specific configuration of niobium capacitor 20 according to this embodiment is described as follows.

Anode 1 is formed by molding metal particles containing niobium (i.e., valve metal) into a specific shape (a rectangular parallelepiped in this embodiment), and then sintering the molded metal particles. Thus, anode 1 is a porous sintered body, in which there are connected fine pores formed by sintered metal particles that had gaps between particles prior to sintering. Anode lead 2 is a needle shaped part having one end portion 2a embedded in anode 1 and the other end portion 2b protruded from anode 1. In this way, anode lead 2 is integrated with anode 1. As for materials for anode lead 2, valve metals may be used. Such valve metals may be different from materials used for anode 1 (for example, Aluminum and the like); however, using niobium for anode lead 2 as used in anode 1 is preferable.

Dielectric layer 3 is a layer containing niobium oxide, which is an oxide formed by anodizing anode 1. Thus, dielectric layer 3 is formed to cover at least a part of anode 1. FIG. 1 shows dielectric layer 3 formed on an outer surface of anode 1. Note that dielectric layer 3 is formed also on a wall surface of each pore (not shown) in the porous body of anode 1.

Cathode layer 4 contains copper and is formed so as to cover at least a part of dielectric layer 3.

FIG. 2 is a perspective view showing a state in which cathode layer 4 is formed on dielectric layer 3 formed on the surface of anode 1. In this embodiment, cathode layer 4 covers a substantially the entire surface of dielectric layer 3 formed on the surface of anode 1 having a rectangular parallelepiped shape. Note that FIGS. 1 and 2 show cathode layer 3 formed on dielectric layer 3 covering anode 1 having a rectangular parallelepiped shape; however, as mentioned above, because anode 1 has a porous body, dielectric layer 3 and cathode layer 4 that covers dielectric layer 3 are formed also on the wall surface of each pore (not shown) in the porous body of anode 1.

Cathode lead layer 5 is formed so as to cover a part of cathode layer 4, and has a laminated structure in which carbon layer 5a and silver paste layer 5b are formed in that order. Carbon layer 5a is a layer containing carbon particles. With such a structure, cathode lead layer 5 is formed so as to be in direct contact with cathode layer 4.

Cathode terminal 9 is attached to cathode lead layer 5. More specifically, cathode terminal 9 is formed by bending a strip of metal plate. A bottom surface of end portion 9a of cathode terminal 9 is bonded to cathode lead layer 5 with conductive adhesive 8 as shown in FIG. 1. In this way, cathode terminal 9 and cathode lead layer 5 are connected to each other mechanically as well as electrically. Examples of a material of the conductive adhesive 8 are a silver paste containing a mixture of silver and epoxy resin, and the like.

Here, cathode lead layer 5 may be formed of any one of carbon layer 5a and silver paste layer 5b, and may have various structures as long as cathode layer 4 and cathode terminal 9 are electrically connected. Moreover, cathode lead layer 5 may be the only layer formed between cathode layer 4 and cathode terminal 9. In this case, cathode layer 4 and cathode terminal 9 are connected via cathode lead layer 5 mechanically as well as electrically.

Anode terminal 7 is attached to anode lead 2. More specifically, anode terminal 7 is formed by bending a strip of metal plate. As shown in FIG. 1, a bottom surface of end portion 7a of anode terminal 7 is connected mechanically as well as electrically to end portion 2b of anode lead 2 by welding or the like.

Examples of a material of anode terminal 7 and cathode terminal 9 are copper, a copper alloy, an iron-nickel alloy (42 alloy) and the like.

Outer resin package 11 is formed so as to cover the exposed portions of cathode layer 4, anode terminal 7 and cathode terminal 9 provided as described above. End portion 7b of anode terminal 7 and end portion 9b of cathode terminal 9 are exposed from side surfaces to a bottom surface of outer resin package 11, and the exposed portions are used to attach to a substrate via soldering. As a material of outer resin package 11, a material that functions as a sealing material is used. Examples of such a material are epoxy resin, silicone resin and the like. Outer resin package 11 may be formed by hardening a resin conditioned by appropriately combining a base resin, a hardener and filler particles.

### Method of Manufacturing Niobium Capacitor According to the First Embodiment

A method of manufacturing the niobium capacitor according to the embodiment is described as follows.

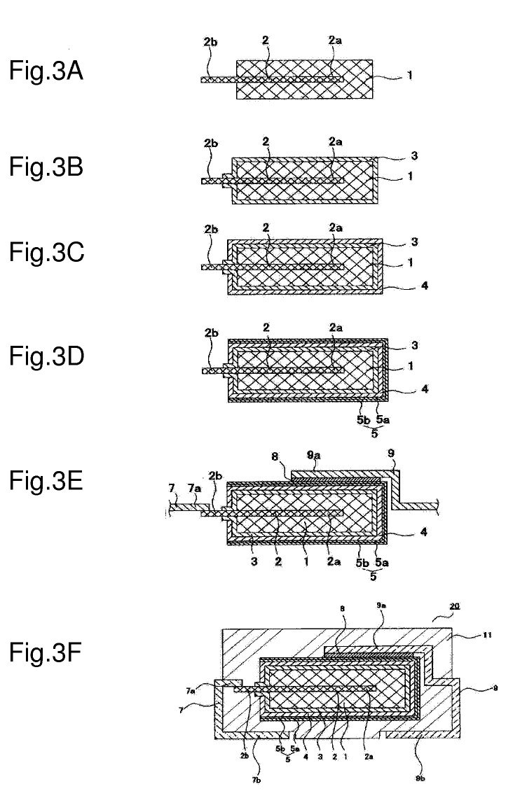

FIGS. 3A-3F show steps for manufacturing the niobium capacitor according to the embodiment.

<Step 1: Formation of Anode>

Anode 1 is formed as follows. First, a molded body within which end portion 2a of anode lead 2 is embedded is formed by molding valve metal particles containing niobium metal having a primary particle size of approximately 0.5 μm as shown in FIG. 3A. Then, anode 1 is formed by sintering the molded body in a vacuum. End portion 2b of anode lead 2 is fixed so as to protrude from one surface of anode 1. The outer shape of anode 1, which is a porous sintered body, is, for example, a rectangular parallelepiped having a length of 4.4 mm, a width of 3.3 mm and a thickness of 1.0 mm.

<Step 2: Formation of Dielectric Layer>

As shown in FIG. 3B, dielectric layer 3 having an oxide film is formed on the surfaces of anode 1 by anodizing anode 1. More specifically, anode 1 is anodized at a constant voltage of approximately 10 V in a phosphoric acid solution for approximately two hours, and thereby dielectric layer 3 containing niobium oxide is formed.

<Step 3: Formation of Cathode Layer>

As shown in FIG. 3C, cathode layer 4 containing copper is formed on the surface of dielectric layer 3 by a plating method. More specifically, first, anode 1 on which dielectric layer 3 is formed is soaked in a plating solution made by dissolving copper sulfate in a phosphoric acid solution. While anode 1 is being soaked, anode lead 2 is fixed so that end portion 2b of anode lead 2 is not soaked in the plating solution. Then, electrodes are connected respectively to end portion 2b of anode lead 2 and a counter electrode made of platinum also soaked in the plating solution. Then, a predetermined voltage is applied to the electrodes. Through this electroplating, cathode layer 4 is formed on dielectric layer 3. Cathode layer 4 has a thickness of approximately 1 μm on the surfaces of anode 1, which is the porous sintered body, having sub-micrometer pores, for example. However, the thickness of cathode layer 4 is not limited to this, but may be of any value between 0.1 μm and 5 mm both inclusive on the surfaces of anode 1. In particular, the thickness is preferably between 0.5 μm and 1 mm both inclusive because such thickness can provide increased durability. Inside anode 1, the thickness of cathode layer 4 may be of any value between 10 nm and 5 μm both inclusive. In particular, the thickness is preferably between 20 nm and 1 μm both inclusive because such thickness can reduce ESR.

Examples of a method for forming cathode layer 4, other than a plating method, are a sputtering method, a vapor deposition method and the like. In the case of employing a sputtering method or a vapor deposition method, cathode layer 4 can be formed on the surface of dielectric layer 3 by rotating an element on which dielectric layer 3 is formed as described above. When anode 1 is a porous body as in this embodiment, formation of cathode layer 4 using a plating method facilitates formation of cathode layer 4 on the surface of dielectric layer 3 formed on the surface of each pore in anode 1, which is a porous body. Moreover, since cathode layer 4 is formed by soaking anode 1 in a plating solution in a plating method, cathode layer 4 is formed covering substantially the entire surface of dielectric layer 3.

<Step 4: Formation of Cathode Lead Layer>

As shown in FIG. 3D, carbon layer 5a is formed by applying a carbon paste to the surface of cathode layer 4 so as to be in direct contact with the surface. Then, silver paste layer 5b is formed by applying silver paste on carbon layer 5a. In this embodiment, cathode lead layer 5 is formed of carbon layer 5a and silver paste layer 5b.

<Step 5: Connections of Anode Terminal and Cathode Terminal>

As shown in FIG. 3E, end portion 7a of anode terminal 7 is electrically and mechanically connected to end portion 2b of anode lead 2 by welding or the like. In addition, end portion 9a of cathode terminal 9 is electrically and mechanically connected to cathode lead layer 5 with the conductive adhesive 8.

<Step 6: Molding Step>

As shown in FIG. 3F, after the formation in step 5, outer resin package 11 is formed by a transfer molding method using a sealing material containing epoxy resin and an imidazole compound, so as to expose a part of each of anode terminal 7 and cathode terminal 9. More specifically, the sealing material which is preheated, is injected into a mold, and is then hardened in the mold. After the formation of outer resin package 11, the exposed portions of anode terminal 7 and cathode terminal 9 are each bent along the corresponding side surface and the bottom surface of outer resin package 11. Thereby, terminal end portions 7b and 9b to be used for soldering to the substrate are formed.

### Second Embodiment

Next, a second embodiment is described below. Note that similar descriptions as those described in the first embodiment are omitted.

In the second embodiment, a plate or a foil (“a plate or a foil” is hereinafter referred to as “a plate”) containing niobium is used for anode 1, instead of a porous sintered body made of niobium as used in the first embodiment.

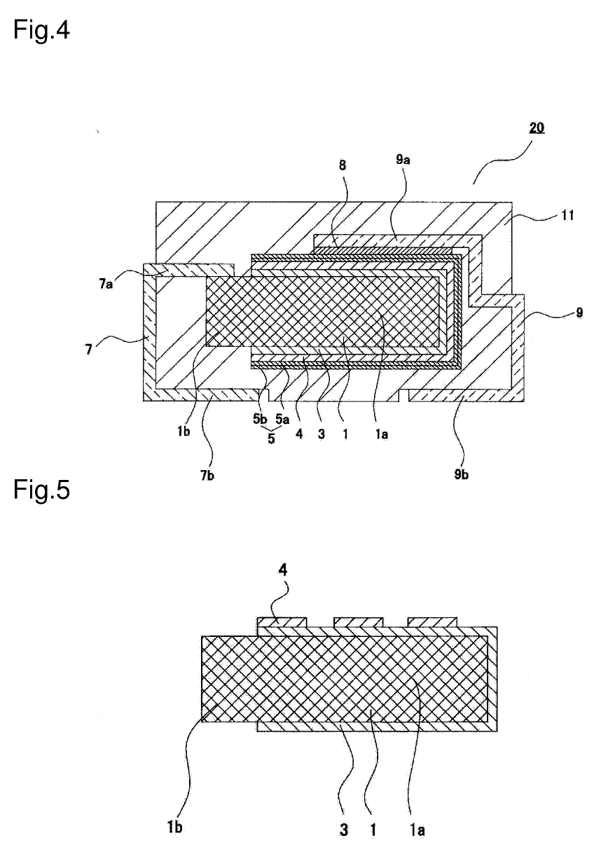

FIG. 4 is a schematic cross-sectional view for describing the inside of niobium capacitor 20 according to this embodiment. A portion, on the side of end portion 1a, of anode 1 formed of a plate containing niobium is anodized, and thereby dielectric layer 3 is formed. End portion 7a of anode terminal 7 is connected to a top surface at the side of end portion 1b of anode 1. Thus, unlike the niobium capacitor described in the first embodiment, an anode lead is not required in this case of niobium plate used for anode 1.

Moreover, in the case of a plate containing niobium used for anode 1, cathode layer 4 can be formed uniformly on dielectric layer 3 using a sputtering method or a vapor deposition method by appropriately rotating anode 1.

The third embodiment is an electronic device using the niobium capacitor of the first embodiment shown in FIG. 1 or the niobium capacitor of the second embodiment shown in FIG. 4. Examples of the electronic device according to the third embodiment are information-processing devices such as a personal computer and a PDA, imaging devices such as a television, a hard disc recorder, a DVD recorder, a blue ray recorder, a digital camera, and a video camera, acoustic devices such as a MP3 audio player and a hard disc audio player, and communication devices such as a telephone, a cellular phone, and a facsimile device, but not limited to these examples. These electronic devices are controlled by a CPU or microcomputer, or signal-processed by DSP and the like.

In the electronic device according to the third embodiment, a power wire that supplies a source voltage and a ground wire are provided from a power circuit to a semiconductor integrated circuit including these CPU, microcomputer, and DSP. The niobium capacitor having the abovementioned configuration is connected so as to bridge the power wire and the ground wire. The niobium capacitor functions as a filter capacitor that prevents voltage fluctuations in the source voltage supplied to the semiconductor integrated circuit.

(Evaluation)

In order to measure leakage current, evaluation samples for an example and comparative examples were manufactured using the following steps. FIG. 5 is a cross-sectional view schematically showing the solid electrolytic capacitors according to any one of the evaluation samples. As shown in FIG. 5, the evaluation sample includes anode 1, dielectric layer 3 and cathode layer 4, which constitute the basic configuration capable of functioning according to any one of the aforementioned embodiments. With such an evaluation sample, a leakage current occurring between anode 1 and cathode 4 of the niobium capacitor according to the abovementioned embodiment can be detected and evaluated as explained below.

### EXAMPLE 1

Anode 1 used in Example 1 for an evaluation sample has a plate-like shape and contains niobium of 99.9% purity. Anode 1 is formed by rolling to be 20 mm long, 40 mm wide and 1 mm thick. Surfaces of end portion 1a of anode 1 are anodized in a phosphoric acid solution of 0.5 wt % at a constant voltage of approximately 80 V and a limiting current of 10 mA/400 mm² for approximately four hours. By this anodization, dielectric layer 3 containing niobium oxide is formed. The film thickness of dielectric layer 3 thus formed is 220 nm as determined by cross-section observation using a transmission electron microscope.

Then, cathode layer 4 containing copper is formed by a vapor deposition method using a resistive heater on dielectric layer 3 containing niobium oxide that is formed on a part of the plate-like shaped anode 1 containing niobium. For the vapor deposition, a masking-plate made of stainless steel with holes of diameter 1.5 mm and pitch 5 mm is used. The film thickness of cathode layer 4 thus obtained is approximately 1 μm as determined by an evaluation using a fluorescent X-ray apparatus.

Next, a combination of a manual probe and a semiconductor parameter analyzer (4156A manufactured by Agilent Technologies) is used to measure the current-voltage characteristic of the niobium capacitor used as the evaluation sample in Example 1. Results are as follows: when a voltage is +15(V), namely, when 15V of voltage is applied in the forward direction, the value of the current per electrode 4 is 1.53E-6(A). When a voltage is −15(V), namely, when 15V of voltage is applied in the reverse direction, the value of a current per electrode 4 is 2.02E-6(A). The results of this evaluation are shown in Table 1 below.

### Comparative Example 1

A niobium capacitor as an evaluation sample for Comparative Example 1 is formed in the same manner as in Example 1 except that aluminum is used for forming cathode layer 1 instead of copper as in the evaluation sample in Example 1. In Comparative Example 1, cathode layer 4 containing aluminum is formed by a vapor deposition method using a resistive heater. The film thickness of cathode 4 containing aluminum thus obtained is approximately 1000 nm as determined by evaluation using a fluorescent X-ray apparatus.

Measurements in the evaluation sample for Comparative Example 1 are conducted in the same manner as in Example 1. Measurement results are indicated in Table 1 below.

### Comparative Example 2

A niobium capacitor according to Comparative Example 2 is manufactured in the same way as Comparative example 1 except that cathode layer 4 is formed by using platinum instead of copper as used in Comparative Example 1. Cathode layer 4 using platinum is formed by a sputtering method as described below.

The cathode layer 4 of platinum is formed by using platinum of 99.9% purity as a target under sputtering conditions in which the total pressure is 1.2 mTorr (Ar pressure), the RF power is 200 W, and the time is 20 minutes. The film thickness of the platinum thus obtained is approximately 650 nm as determined by an evaluation using a fluorescent X-ray apparatus.

Measurements in the evaluation sample for Comparative Example 2 are conducted in the same manner as in Example 1. Measurement results are indicated in Table 1 below.

### Comparative Example 3

Anode 1 used in Comparative Example 3 for an evaluation sample has a plate-like shape and contains tantalum of 99.9% purity. Anode 1 is formed by rolling to be 20 mm long, 40 mm wide and 1 mm thick. A part of the surface of anode 1 containing tantalum is not anodized in order to attach a lead to anode 1. The anodization is conducted using phosphoric acid solution of 0.5 wt % at a constant voltage of approximately 80 V and a limiting current of 10 mA/400 mm² for approximately four hours. A dielectric layer 3 containing tantalum oxide is formed by this anodization. The film thickness of the dielectric layer 3 thus formed is approximately 120 nm as determined by a cross-section observation using a transmission electron microscope.

Then, cathode layer 4 containing copper is formed by a vapor deposition method using a resistive heater on dielectric layer 3 containing tantalum oxide that is formed on a part of the plate-like shaped anode 1 containing tantalum. For the vapor deposition, a masking plate made of stainless steel with holes of diameter 1.5 mm and pitch 5 mm is used. The film thickness of cathode layer 4 thus obtained is approximately 1 μm as determined by an evaluation using a fluorescent X-ray apparatus.

Measurements in the evaluation sample for Comparative Example 3 are conducted in the same manner as in Example 1. Measurement results are indicated in Table 1 below.

Measurement results of the aforementioned Example 1 and Comparative Examples 1-3 are indicated in Table 1.

TABLE 1

| | | Comparative | Comparative | Comparative |
|---|---|---|---|---|
| | Example 1 | Example 1 | Example 2 | Example 3 |
| Current value (A) | 1.53E−06 | 5.42E−03 | 5.55E−06 | 2.37E−09 |
| when a voltage is | | | | |
| applied in the | | | | |
| forward direction | | | | |
| Current value (A) | 2.02E−06 | 4.14E−04 | 8.43E−04 | 6.04E−06 |
| when a voltage is | | | | |
| applied in the | | | | |
| reverse direction | | | | |

Table 1 indicates that the niobium capacitor of Example 1 having a copper cathode has the smallest current value when a voltage is applied in the forward direction, namely, the current leakage in the forward direction, compared to that of niobium capacitors in Comparative Examples 1 and 2.

Table 1 also indicates that the niobium capacitor of Example 1 having a copper cathode has the smallest current value when a voltage is applied in the reverse direction, namely, the current leakage in the reverse direction, compared to that of niobium capacitors in Comparative Examples 1 and 2, and that of the tantalum capacitor in Comparative Example 3.

Table 1 further indicates that the niobium capacitor of Example 1 has a “current value when a voltage is applied in the reverse direction”, namely, the current leakage value in the forward direction is substantially equivalent to that of in the reverse direction. That is, the difference of these current values in Example 1 is the smallest compared to other Comparative Examples.

Therefore, the niobium capacitor in Example 1 indicates that the niobium capacitor can prevent current leakages both in the foreword and reverse directions at a substantially equal level (i.e., about a few μA difference).

### Effect of Embodiments

As is clear from the aforementioned evaluation results, niobium capacitors according to embodiments 1 and 2 are capable of reducing current leakages compared to a niobium capacitor having a cathode containing aluminum or platinum.

Also, the niobium capacitor can reduce current leakages both in the foreword and reverse directions. Therefore, even if the niobium capacitor of these embodiments is mistakenly attached to an electronic device such that the power wire and the ground wire are respectively connected to terminals of opposite polarities, damages in the capacitor can be avoided because the capacitor has a small amount of current leakages in the reverse polarity. Such an undamaged capacitor can be used to connect correctly. Therefore, such a capacitor can reduce wasted parts and can contribute to improvement of the yield in manufacturing electric devices.

Further, in the niobium capacitor according to the first and the second embodiments, the cathode layer 4 contains copper (i.e., inorganic material). Therefore, compared to a cathode layer having organic materials such as a conductive polymer, the cathode layer 4 containing copper can also prevent increased ESR by minimizing decrease of conductivity in cathode layer 4 caused by a deterioration of film quality of cathode layer 4 at a high temperature and a decrease of adherence between dielectric layer 3 and cathode layer 4. Therefore, cathode layer 4 according to this embodiment can prevent increased ESR compared to that of organic materials such as a conductive polymer. Accordingly, the reliability of the niobium capacitor used at a high temperature is enhanced.

Also, in general, copper has superior conductivity compared to organic materials such as conductive polymer. The use of copper enhances the conductivity in cathode layer 4 in the embodiment. In this respect, copper has a large effect in reducing ESR.

Further, cathode lead layer 5 is formed to be in a direct contact with cathode layer 4. Compared to a conductive polymer used as a cathode layer, cathode layer 4 containing copper has enhanced electrical conductivity and reliability and thus cathode layer 4 containing copper can reduce ESR that occurs from cathode layer 4 to cathode lead layer 5.

A number of niobium capacitors, according to the third embodiment, having reduced current leakages are used in electronic devices as filter capacitors, thereby reducing loss of electric energy caused by current leakages. Therefore, the electric device can be driven for a longer time as it saves battery consumption, especially in an electric device having superior portability and using a battery as a power source, such as a cellular phone, a PDA, a digital camera, and the like.

### Modification of Embodiments

The aforementioned embodiment uses anode 1 containing niobium. However, an anode containing niobium as a constituent element may be an anode formed of niobium that contains impure substances, or an anode containing a niobium alloy that is formed by alloying niobium with other metals. The aforementioned embodiments use cathode 4 containing copper. However, a cathode including copper as a constituent element may be a cathode formed of copper that contains impure substances, or may be a cathode containing a copper alloy that is formed by alloying copper with other metals.

Current leakage in niobium capacitors is assumed to be prevented by a Schottky barrier formed between the dielectric layer and the cathode. The Schottky barrier in this case corresponds to a value where a bottom value of a conduction band (electron affinity) in a band gap of the dielectric layer is subtracted from a work function value of the cathode; that is, when the work function value of the cathode containing copper is close to the bottom value of the conduction band of the dielectric layer (for example, the difference of these values is 0.1 eV or smaller).

Therefore, when a niobium alloy is used as an anode, a niobium alloy that contains primarily niobium may be used as long as the aforementioned relationship between a work function of the cathode and a conduction band of the dielectric layer is maintained. Considering the range within which a crystallographic transformation in the niobium alloy does not occur, it is preferable that the niobium alloy contains 20% or less of the additive weight of a total weight of the niobium alloy. Examples of additives contained in the niobium alloy which is a material for the anode are: silicon, vanadium, boron, nitrogen, aluminum, titanium, tantalum, tungsten, molybdenum, hafnium and the like. The niobium alloy is formed by adding these additives to niobium. Also, when a copper alloy is used as a cathode, a copper alloy that contains primarily copper may be used as long as the aforementioned relationship between a work function of the cathode and a conduction band of the dielectric layer is maintained.

Considering the range within which a crystallographic transformation in the copper alloy does not occur, it is preferable that the copper alloy contains 10% or less weight of the additive weight of a total weight of the copper alloy.

Examples of additives to be contained in the copper alloy which is a material for the cathode are: aluminum, iron, nickel, manganese, zinc, lead, phosphorus, and the like.

As described above, the capacitor in the embodiments includes an anode containing niobium or niobium alloy, a dielectric layer containing niobium oxide and formed on the anode, and a cathode layer containing copper or copper alloy and formed on the dielectric layer. Current leakages in a solid electrolytic capacitor can be reduced with this configuration.

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

What is claimed is:

1. A solid electrolytic capacitor comprising:
an anode including any one of niobium and a niobium alloy;
a dielectric layer formed on the anode, wherein the dielectric layer contains niobium oxide; and
a cathode layer formed on the dielectric layer, wherein the cathode layer contains copper.

2. The solid electrolytic capacitor according to claim 1, wherein an energy difference between a work function value of the cathode and a bottom value of a conduction band in a band gap of the dielectric layer is 0.1 eV or smaller.

3. The solid electrolytic capacitor according to claim 1, wherein the anode is a niobium alloy including any one additive selected from silicon, vanadium, boron, nitrogen, aluminum, titanium, tantalum, tungsten, molybdenum, and hafnium.

4. The solid electrolytic capacitor according to claim 3, wherein a weight of the additive is 20% of a total weight of the niobium alloy or smaller.

5. A solid electrolytic capacitor comprising:
an anode including any one of niobium and a niobium alloy;
a dielectric layer formed on the anode, wherein the dielectric layer contains niobium oxide; and
a cathode layer formed on the dielectric layer, wherein the cathode layer includes a copper alloy.

6. The solid electrolytic capacitor according to claim 5, wherein the copper alloy includes any one additive selected from aluminum, iron, nickel, manganese, zinc, lead and phosphorus.

7. The solid electrolytic capacitor according to claim 6, wherein a weight of the additive is 10% of a total weight of the copper alloy or smaller.

8. The solid electrolytic capacitor according to claim 1, wherein the solid electrolytic capacitor is used in an electronic device.

9. The solid electrolytic capacitor according to claim 8, wherein the electronic device is any one of an information-processing device, an imaging device, an acoustic device, and a communicating device.

10. A method of manufacturing a solid electrolytic capacitor, comprising steps of:
forming an anode containing any one of niobium and a niobium alloy;
forming a dielectric layer including niobium oxide by anodization so as to cover at least part of the anode;
forming a cathode layer including any one of copper and copper alloy, so as to cover at least part of the dielectric layer.

11. The method of manufacturing a solid electrolytic capacitor according to claim 10, wherein the cathode layer is formed by any one of a plating method, a sputtering method and a vapor deposition method.

12. The method of manufacturing a solid electrolytic capacitor according to claim 10, wherein steps of forming the cathode layer comprises:
soaking the anode on which the dielectric layer is formed, in a plating solution made by dissolving copper sulfate in a phosphoric acid solution; and
applying a predetermined voltage to the anode and a counter electrode soaked in the plating solution.
